(19) United States
(12) Patent Application Publication
(10) Pub. No.: US 2020/0015431 A1
(43) Pub. Date: Jan. 16, 2020

(54) Plant Support Assembly

(71) Applicant: Tom Kirk, Kenmore, WA (US)

(72) Inventor: Tom Kirk, Kenmore, WA (US)

(21) Appl. No.: 16/032,123

(22) Filed: Jul. 11, 2018

(51) Int. Cl. A01G 9/12; A01G 9/04; B62B 5/00

(52) U.S. Cl. CPC A01G 9/12; B62B 2202/70; B62B 5/0083; A01G 9/045

(57) ABSTRACT

A plant support assembly for facilitating the growing of plants includes a plate and a frame that is octagonally shaped. A net is coupled to and extends inwardly from the frame. A plurality of rods is coupled to and extends between the plate and the frame. Each rod comprises a plurality of nested sections so that the rod is selectively extensible. A plurality of rollers is coupled to a lower surface of the plat. The net is configured to support stems and leaves of a plant that is growing from a container that is positioned on an upper surface of the plate. The rollers are configured to roll on a horizontal surface to selectively position the plate.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to support assemblies and more particularly pertains to a new support assembly for facilitating the growing of plants.

### BRIEF SUMMARY OF THE INVENTION

An embodiment of the disclosure meets the needs presented above by generally comprising a plate and a frame that is octagonally shaped. A net is coupled to and extends inwardly from the frame. A plurality of rods is coupled to and extends between the plate and the frame. Each rod comprises a plurality of nested sections so that the rod is selectively extensible. A plurality of rollers is coupled to a lower surface of the plat. The net is configured to support stems and leaves of a plant that is growing from a container that is positioned on an upper surface of the plate. The rollers are configured to roll on a horizontal surface to selectively position the plate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a plant support assembly according to an embodiment of the disclosure.

FIG. 2 is a bottom view of an embodiment of the disclosure.

FIG. 3 is a side view of an embodiment of the disclosure.

FIG. 4 is a side view of an embodiment of the disclosure.

FIG. 5 is a top view of an embodiment of the disclosure.

### DETAILED DESCRIPTION OF THE INVENTION

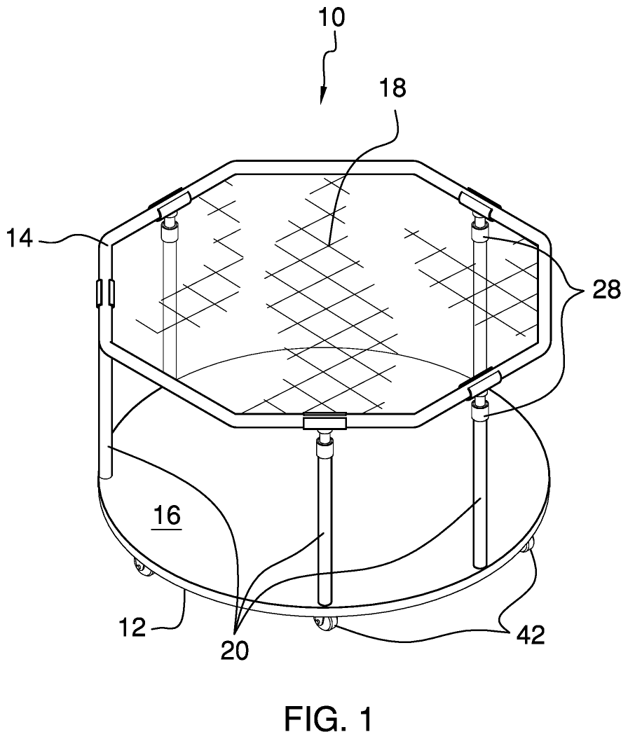

With reference now to the drawings, and in particular to FIGS. 1 through 5 thereof, a new support assembly embodying the principles and concepts of an embodiment of the disclosure and generally designated by the reference numeral 10 will be described.

As best illustrated in FIGS. 1 through 5, the plant support assembly 10 generally comprises a plate 12 and a frame 14. The plate 12 is circularly shaped. The frame 14 is octagonally shaped. The plate 12 has an upper surface 16 that is white so that the upper surface 16 is configured to reflect light. The frame 14 is tubular. The frame 14 comprises plastic, or the like, so that the frame 14 is configured to resist water.

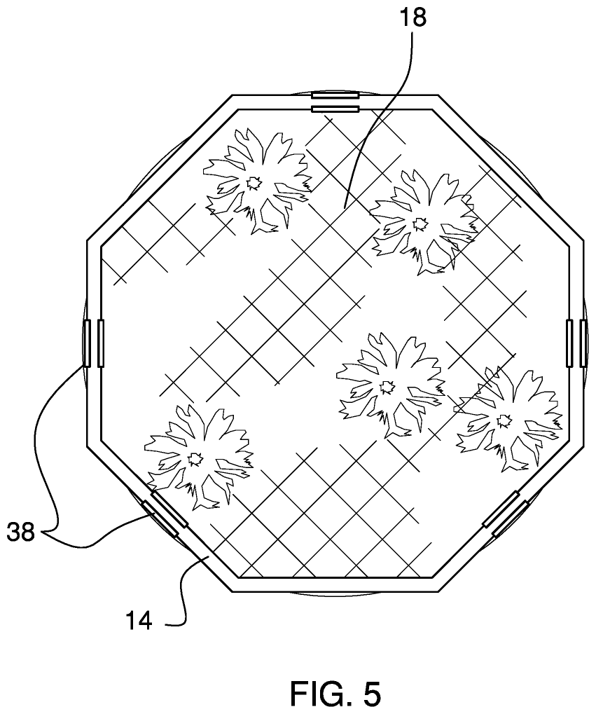

A net 18 is coupled to and extends inwardly from the frame 14, as shown in FIG. 5. The net 18 is configured to support stems and leaves of a plant that is growing from a container that is positioned on the upper surface 16 of the plate 12, as shown in FIG. 5. The net 18 comprises plastic, or the like, so that the net 18 is configured to resist water.

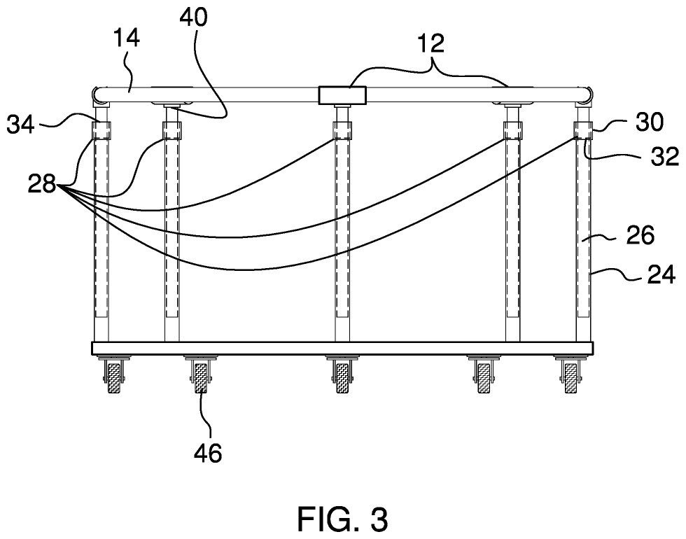

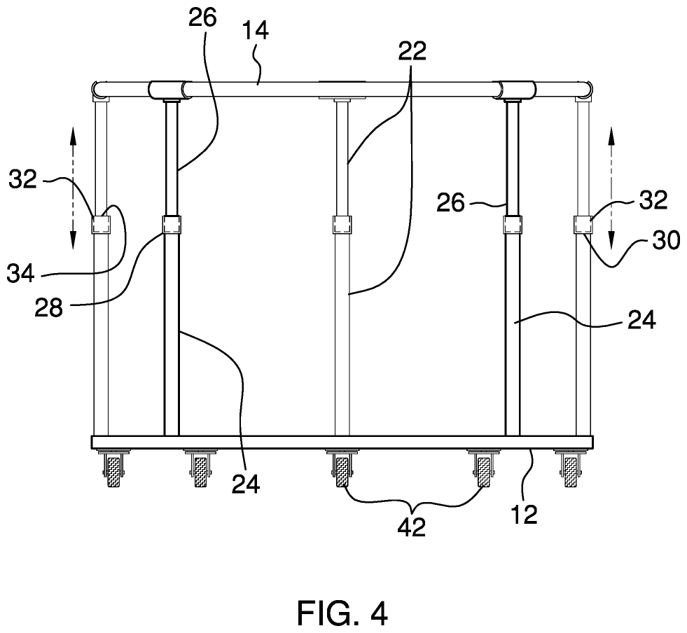

A plurality of rods 20 is coupled to and extends between the plate 12 and the frame 14, as shown in FIG. 3. Each rod 20 comprises a plurality of nested sections 22 so that the rod 20 is selectively extensible, as shown in FIG. 4. The plurality of rods 20 comprises five rods 20. The plurality of nested sections 22 comprises a lower segment 24 that is coupled to the plate 12 and an upper segment 26 that is coupled to the frame 14. The rods 20 comprise plastic, or the like, so that the rods 20 are configured to resist water.

Each of a plurality of couplers 28 is coupled to an associated lower segment 24 proximate to an upper end 32 of the associated lower segment 24. The couplers 28 are compression type so that rotation of an outer ring 30 of the coupler 28 relative to the associated lower segment 24 induces compression of an inner ring 32 of the coupler 28 to couple an associated upper segment 26 to the associated lower segment 24 so that the net 18 is selectively positionable relative to the plate 12, as shown in FIG. 4.

Each of a plurality of clamps 38 is coupled to a top end 40 of a respective rod 20, as shown in FIG. 3. The clamp 38 is positioned to couple to the frame 14 to couple the respective rod 20 to the frame 14. The clamps 38 comprise plastic, or the like, so that the clamps 38 are configured to resist water.

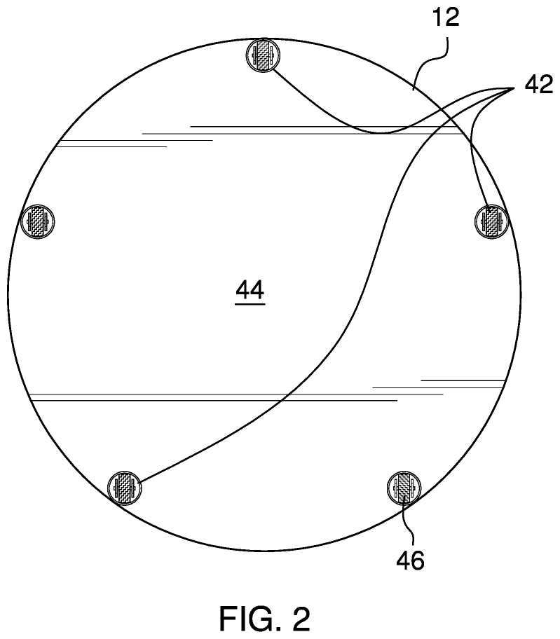

A plurality of rollers 42 is coupled to a lower surface 44 of the plate 12, as shown in FIG. 2. The rollers 42 are configured to roll on a horizontal surface to selectively position the plate 12, such as within a growing tent. The rollers 42 are rotationally coupled to the plate 12 so that each roller 42 is positioned to be rotated relative to the plate 12 so that the plate 12 is configured to be rotated relative to the horizontal surface. This allows the plate 12 and frame 14, along with plants that are growing in containers that are positioned on the plate 12, to be rotated within the growing tent. A user is positioned to tend to each of the plants, in sequence through an opening positioned in the growing tent, as the plate 12 is rotated. Each roller 42 comprises a wheel 46. The plurality of rollers 42 comprises five rollers 42.

In use, each upper segment 26 is selectively extendable from an associated lower segment 24 so that the net 18 is selectively positionable relative to the plate 12. The net 18 is configured to support the stems and the leaves of the plants that grow from the containers that are positioned on the upper surface 16 of the plate 12. The rollers 42 are configured to roll and to rotate on the horizontal surface to selectively position the plate 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A plant support assembly comprising:
a plate;
a frame, said frame being octagonally shaped;
a plurality of rods coupled to and extending between said plate and said frame, each said rod comprising a plurality of nested sections such that said rod is selectively extensible;
a net coupled to and extending inwardly from said frame wherein said net is configured for supporting stems and leaves of a plant growing from a container positioned on an upper surface of said plate;
a plurality of rollers coupled to a lower surface of said plat wherein said rollers are configured for rolling on a horizontal surface for selectively positioning said plate.

2. The assembly of claim 1, further including said plate being circularly shaped.

3. The assembly of claim 1, further including said upper surface being white wherein said upper surface is configured for reflecting light.

4. The assembly of claim 1, further including said frame being tubular.

5. The assembly of claim 1, further including said frame comprising plastic such that said frame is configured for resisting water.

6. The assembly of claim 1, further including said net comprising plastic wherein said net is configured for resisting water.

7. The assembly of claim 1, further including said plurality of rods comprising five said rods.

8. The assembly of claim 1, further including said rods comprising plastic such that said rods are configured for resisting water.

9. The assembly of claim 1, further including said plurality of nested sections comprising a lower segment coupled to said plate and an upper segment coupled to said frame.

10. The assembly of claim 9, further including a plurality couplers, each said pair of coupler being coupled to an associated said lower segment proximate to an upper end of said associated said lower segment, said couplers being compression type such that rotation of an outer ring of said coupler relative to said associated lower segment induces compression of an inner ring of said coupler onto an associated said upper segment for coupling said associated said upper segment to said associated said lower segment such that said net is selectively positionable relative to said plate.

11. The assembly of claim 1, further including a plurality of clamps, each said clamp being coupled to a top end of a respective said rod wherein said clamp is positioned for coupling to said frame for coupling said respective said rod to said frame.

12. The assembly of claim 11, further including said clamps comprising plastic such that said clamps are configured for resisting water.

13. The assembly of claim 1, further including said rollers being rotationally coupled to said plate wherein each said roller is positioned for rotating relative to said plate such that said plate is configured for being rotated relative to the horizontal surface.

14. The assembly of claim 1, further including each said roller comprising a wheel.

15. The assembly of claim 1, further including said plurality of rollers comprising five said rollers.

16. A plant support assembly comprising:
a plate, said plate being circularly shaped, said plate having an upper surface, said upper surface being white wherein said upper surface is configured for reflecting light;
a frame a frame, said frame being octagonally shaped, said frame being tubular, said frame comprising plastic such that said frame is configured for resisting water;
a net coupled to and extending inwardly from said frame wherein said net is configured for supporting stems and leaves of a plant growing from a container positioned on said upper surface of said plate, said net comprising plastic wherein said net is configured for resisting water;
a plurality of rods coupled to and extending between said plate and said frame, each said rod comprising a plurality of nested sections such that said rod is selectively extensible, said plurality of rods comprising five said rods, said plurality of nested sections comprising a lower segment coupled to said plate and an upper segment coupled to said frame, said rods comprising plastic such that said rods are configured for resisting water;
a plurality couplers, each said pair of coupler being coupled to an associated said lower segment proximate to an upper end of said associated said lower segment, said couplers being compression type such that rotation of an outer ring of said coupler relative to said associated lower segment induces compression of an inner ring of said coupler onto an associated said upper segment for coupling said associated said upper segment to said associated said lower segment such that said net is selectively positionable relative to said plate;
a plurality of clamps, each said clamp being coupled to a top end of a respective said rod wherein said clamp is positioned for coupling to said frame for coupling said respective said rod to said frame, said clamps comprising plastic such that said clamps are configured for resisting water;
a plurality of rollers coupled to a lower surface of said plate wherein said rollers are configured for rolling on a horizontal surface for selectively positioning said plate, said rollers being rotationally coupled to said plate wherein each said roller is positioned for rotating relative to said plate such that said plate is configured for being rotated relative to the horizontal surface, each said roller comprising a wheel, said plurality of rollers comprising five said rollers.
